(19) United States
(12) Patent Application Publication
(10) Pub. No.: US 2014/0192648 A1
(43) Pub. Date: Jul. 10, 2014

(54) Method and Apparatus for Sending Non-Data Frame

(71) Applicant: Huawei Technologies Co., Ltd., Shenzhen (CN)

(72) Inventors: Xuehuan Wang, Chengdu (CN); Linfeng Xia, Chengdu (CN); Long Luo, Chengdu (CN)

(73) Assignee: HUAWEI TECHNOLOGIES CO., LTD., Shenzhen (CN)

(21) Appl. No.: 14/203,196

(22) Filed: Mar. 10, 2014

Related U.S. Application Data
(63) Continuation of application No. PCT/CN2012/081381, filed on Sep. 14, 2012.

(30) Foreign Application Priority Data
Sep. 14, 2011 (CN) 201110271945.3

(51) Int. Cl. H04L 12/851; H04L 12/863

(52) U.S. Cl. CPC H04L 47/2408; H04L 47/6215
USPC 370/235

(57) ABSTRACT

Embodiments of the present invention provide a method and an apparatus for sending a non-data frame. The method for sending a non-data frame includes: determining an access category for which a transmission opportunity of a shared medium has been obtained, where the obtained transmission opportunity of the shared medium is obtained for the access category through contention according to an enhanced distributed channel access mechanism; and sending a non-data frame according to the access category for which the transmission opportunity of the shared medium has been obtained. In this way, different quality-of-service requirements of a non-data frame and a data frame are met while fairness is considered, thereby avoiding that a management and control message is not sent in time because a non-data frame and a data frame are transmitted according to a same access category.

This application is a continuation of International Application No. PCT/CN2012/081381, filed on Sep. 14, 2012, which claims priority to Chinese Patent Application No. 201110271945.3, filed on Sep. 14, 2011, both of which are hereby incorporated by reference in their entireties.

### TECHNICAL FIELD

Embodiments of the present invention relate to the field of communications technologies, and in particular, to a method and an apparatus for sending a non-data frame.

### BACKGROUND

Since 1997, the IEEE802.11 work group has made standards one after another, such as the IEEE802.11a/b/g/n. Currently, the IEEE802.11ac standard is being made, and the standard is downward compatible with the IEEE802.11n standard. In a shared-media access process of an IEEE802.11/WLAN (Wireless Local Area Networks), in order to reduce an access collision probability of each STA (Station) during wireless communications, a MAC (Media Access Control) layer uses a CSMA/CA (Carrier Sense Multiple Access with Collision Avoidance) mechanism, which is called a DCF (Distributed Coordination Function) in the IEEE 802.11 standard, to monitor a channel and avoid collision. To enhance WLAN quality of service QoS (Quality of Service) guarantee capability, the IEEE802.11e standard has introduced an EDCA (Enhanced Distribution Channel Access) mechanism based on the DCF. The IEEE802.11ac continues to use the EDCA mechanism.

In the EDCA mode, a MAC SDU (MSDU, MAC Service Data Unit) that needs to be transmitted is divided into four queues, and each queue corresponds to an access category AC (Access Category). In each non-idle queue, an access function instance of the EDCA mechanism runs according to an access parameter of the access category AC, so as to perform transmission opportunity TXOP (Transmission Opportunity) contention.

The EDCA mechanism defines four access categories ACs, which are a voice category AC_VO, a video category AC_VI, a best-effort category AC_BE, and a background category AC_BK, respectively. The EDCA differentiates access priorities of different services, and the priorities are as follows in ascending order: the background category AC_BK, the best-effort category AC_BE, the video category AC_VI, and the voice category AC_VO.

In the IEEE802.11ac, MAC frames are classified into data frames and non-data frames (such as a management frame and a control frame). As described in the foregoing, for a data frame, the IEEE802.11ac uses the EDCA mechanism to perform, according to a service type and the four access categories ACs, channel contention; and for a management frame, transmission is performed according to the voice category AC_VO.

In the prior art, the following defect exists in a channel contention mechanism for a non-data frame: In the prior art, a non-data frame is queued and sent along with a certain type of data (such as data of the voice category AC_VO) in a same buffer. Therefore, a difference between the non-data frame and a data frame cannot be reflected in terms of a quality-of-service requirement, and timely transmission of a management and control message cannot be ensured.

### SUMMARY OF THE INVENTION

Embodiments of the present invention provide a method and an apparatus for sending a non-data frame, which can improve quality of service of a non-data frame.

According to one aspect, a method for sending a non-data frame is provided, which includes: determining an access category for which a transmission opportunity of a shared medium has been obtained, where the obtained transmission opportunity of the shared medium is obtained for the access category through contention according to an enhanced distributed channel access mechanism; and sending a non-data frame according to the access category for which the transmission opportunity of the shared medium has been obtained.

According to another aspect, an apparatus for sending a non-data frame is provided, which includes: a determining unit, configured to determine an access category for which a transmission opportunity of a shared medium has been obtained, where the obtained transmission opportunity of the shared medium is obtained for the access category through contention according to an enhanced distributed channel access mechanism; and a sending unit, configured to send a non-data frame according to the access category for which the transmission opportunity of the shared medium has been obtained.

According to the embodiments of the present invention, different quality-of-service requirements of a non-data frame and a data frame can be met based on a transmission opportunity TXOP while fairness is considered, thereby avoiding that a management and control message is not sent in time because a non-data frame and a data frame are transmitted according to a same access category AC.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for sending a non-data frame according to an embodiment of the present invention; and

FIG. 2 is a schematic structural diagram of an apparatus for sending a non-data frame according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

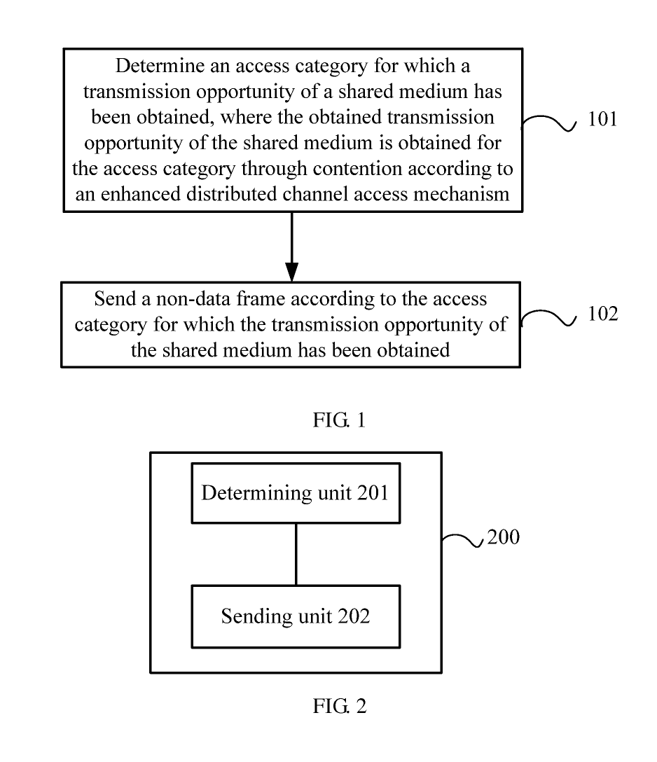

The following describes a method for sending a non-data frame according to an embodiment of the present invention with reference to a flowchart shown in FIG. 1.

101. Determine an access category for which a transmission opportunity of a shared medium has been obtained, where the obtained transmission opportunity of the shared medium is obtained for the access category through contention according to an enhanced distributed channel access mechanism.

That is to say, an access category for which a transmission opportunity of a shared medium has been obtained is determined, where the obtained transmission opportunity of the shared medium is obtained through contention among multiple access categories for the transmission opportunity of the shared medium according to an enhanced distributed channel access mechanism.

The multiple access categories include two or more of the following categories: a background category, a best-effort category, a video category, and a voice category. The multiple access categories ACs may be one or more access categories ACs of a relatively high priority, such as the voice category AC_VO or the video category AC_VI. According to priorities of the access categories ACs, the voice category AC_VO takes precedence over the video category AC_VI, the video category AC_VI takes precedence over the best-effort category AC_BE, and the best-effort category AC_BE takes precedence over the background category AC_BK. Therefore, transmission opportunity TXOP contention may be performed for only the voice category AC_VO and the video category AC_VI, so as to save contention time. In addition, the access category AC for which the transmission opportunity of the shared medium has been obtained may also be one randomly selected from the four access categories ACs.

102. Send a non-data frame according to the access category for which the transmission opportunity of the shared medium has been obtained.

In this embodiment of the present invention, a non-data frame may be sent according to the access category.

When a transmission opportunity TXOP has been obtained for a certain access category AC through contention, a non-data frame is sent preferentially according to the access category AC within the transmission opportunity TXOP.

Optionally, a data frame and a non-data frame that correspond to the access category AC are queued according to waiting time, and sent according to a queuing result within the transmission opportunity TXOP. For example, a non-data frame and/or a data frame are sent by priority according to the access category AC for which a transmission opportunity TXOP has been obtained through contention. The priority includes a priority of a user, a non-data frame property, and/or message urgency.

Specifically, for a non-data frame, a broadcast frame or a unicast frame may be preferentially sent. Alternatively, a priority of a non-data frame may be determined according to the non-data frame property. For example, a management frame is preferentially sent, or a control frame is preferentially sent. Further, in management frames or control frames, a priority of each management frame or each control frame may also be arranged, for example, according to urgency of each message. For example, a request-to-send (RTS) message takes precedence over a power-saving polling (PS-Poll) message, and the power-saving polling (PS-Poll) message takes precedence over a contention-free end (CF-End) message. A priority of a data frame may also be determined according to urgency. For example, a TCP/IP (Transmission Control Protocol/Internet Protocol, Transmission Control Protocol/Internet Protocol) feedback takes precedence over a common data frame.

The method for sending a non-data frame according to this embodiment of the present invention may be applied between a station STA and an access point AP (Access Point). The station STA must be associated with the access point AP, so as to implement data transmission with the access point AP. Before the association, the station STA needs to receive a beacon frame that is periodically sent by the access point AP. The beacon frame carries some basic information of a network, so that the station STA can be associated with the access point AP. In the association process, security authentication is performed between the access point AP and the station STA to establish a secure and reliable communications mechanism for exchanging necessary basic information. That is to say, the access point AP obtains a protocol stack, a feature, and capability that are supported by the station STA, and the access point AP sends to the station STA a specific parameter which is necessary for running of the access point AP.

In a scenario where the station STA communicates with the access point AP, the access point AP may determine a priority of the station STA according to a priority of a user; then queue, according to data frame preference or non-data frame preference that corresponds to the access category AC inside the user, a data frame and a non-data frame of the user; and finally perform sending according to a queuing result within the transmission opportunity TXOP. The priority of the user includes a subscription level of the user, waiting time of a data frame of the user, or waiting time of a non-data frame of the user.

The method for sending a non-data frame according to this embodiment of the present invention may be implemented by a station or an access point, so that different quality-of-service requirements of a non-data frame (a management frame or a control frame) and a data frame can be met while fairness is considered, thereby avoiding that a management and control message is not sent in time because a non-data frame (a management frame or a control frame) and a data frame are transmitted according to a same access category AC.

The following describes an apparatus for sending a non-data frame according to an embodiment of the present invention with reference to a schematic structural diagram shown in FIG. 2. The apparatus 200 for sending a non-data frame according to this embodiment of the present invention includes a determining unit 201 and a sending unit 202. The determining unit 201 is configured to determine an access category for which a transmission opportunity of a shared medium has been obtained, where the obtained transmission opportunity of the shared medium is obtained for the access category through contention according to an enhanced distributed channel access mechanism. That is to say, the determining unit 201 is configured to determine an access category for which a transmission opportunity of a shared medium has been obtained, where the obtained transmission opportunity of the shared medium is obtained through contention among multiple access categories for the transmission opportunity of the shared medium according to an enhanced distributed channel access mechanism. The sending unit 202 may be configured to send a non-data frame according to the access category for which the transmission opportunity of the shared medium has been obtained. All access categories include a background category AC_BK, a best-effort category AC_BE, a video category AC_VI, and a voice category AC_VO. The multiple access categories include two or more of the following categories: the background category, the best-effort category, the video category, and the voice category. Particularly, in addition, the access category AC for which the transmission opportunity of the shared medium has been obtained may be one or more ACs of a relatively high priority.

A non-data frame is queued according to a priority, which is the same as that in the method for sending a non-data frame according to an embodiment of the present invention. Here, the priority includes a priority of a user, a non-data frame property, and/or message urgency.

For the apparatus for sending a non-data frame according to this embodiment of the present invention, different quality-of-service requirements of a non-data frame (a management frame or a control frame) and a data frame can be met while fairness is considered, thereby avoiding that a management and control message is not sent in time because a non-data frame (a management frame or a control frame) and a data frame are transmitted according to a same access category.

It should be understood that the method and the apparatus for sending a non-data frame according to the embodiments of the present invention may be applied between a station STA and another station STA, or applied between a station STA and an access point AP. An access point AP itself is a station, and is a central station that implements management and control on a network. Generally, on a network where there is no access point AP, a certain station STA may, within a certain time period, exist as a central station and manage the network.

In addition, a person of ordinary skill in the art should also understand that the foregoing network is not limited to a basic service set (BSS) network, an overlapping basic service set (OBSS) network, and an extended service set (ESS) network.

A person of ordinary skill in the art may be aware that, in combination with the examples described in the embodiments disclosed in this specification, units and algorithm steps may be implemented by electronic hardware, or a combination of computer software and electronic hardware. Whether the functions are performed by hardware or software depends on the particular applications and design constraint conditions of the technical solution. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and the parts displayed as units may or may not be physical units, may be located in one position, or may be distributed on a plurality of network units. A part of or all of the units may be selected according to actual needs to achieve the objectives of the solutions of the embodiments.

In addition, functional units in the embodiments of the present invention may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for sending a non-data frame comprising:
determining, by an apparatus, an access category for which a transmission opportunity of a shared medium has been obtained, wherein the transmission opportunity of the shared medium is obtained for the access category through contention among a plurality of access categories according to an enhanced distributed channel access mechanism; and
sending the non-data frame according to the access category for which the transmission opportunity of the shared medium has been obtained.

2. The method according to claim 1, wherein the non-data frame is queued according to a priority.

3. The method according to claim 2, wherein the plurality of access categories comprise at least two of a background category, a best-effort category, a video category, and a voice category.

4. The method according to claim 2, wherein the access category comprises an access category of a relatively high priority.

5. The method according to claim 2, wherein the priority comprises at least one of a priority of a user, a non-data frame property, and message urgency.

6. The method according to claim 5, wherein the plurality of access categories comprise at least two of a background category, a best-effort category, a video category, and a voice category.

7. The method according to claim 5, wherein the access category comprises an access category of a relatively high priority.

8. The method according to claim 1, wherein the plurality of access categories comprise at least two of a background category, a best-effort category, a video category, and a voice category.

9. The method according to claim 1, wherein the access category comprises an access category of a relatively high priority.

10. An apparatus for sending a non-data frame, comprising:
a processor configured to determine an access category for which a transmission opportunity of a shared medium has been obtained, wherein the transmission opportunity of the shared medium is obtained for the access category through contention among a plurality of access categories according to an enhanced distributed channel access mechanism; and
a transmitter configured to send the non-data frame according to the access category for which the transmission opportunity of the shared medium has been obtained.

11. The apparatus according to claim 10, wherein the plurality of access categories comprise at least two of a background category, a best-effort category, a video category, and a voice category.

12. The apparatus according to claim 10, wherein the access category comprises an access category of a relatively high priority.

13. The apparatus according to claim 10, wherein the non-data frame is queued according to a priority.

14. The apparatus according to claim 13, wherein the priority comprises at least one of a priority of a user, a non-data frame property, and message urgency.

15. The apparatus according to claim 14, wherein the plurality of access categories comprise at least two of a background category, a best-effort category, a video category, and a voice category.

16. The apparatus according to claim 14, wherein the access category comprises an access category of a relatively high priority.

17. The apparatus according to claim 13, wherein the plurality of access categories comprise at least two of a background category, a best-effort category, a video category, and a voice category.

18. The apparatus according to claim 13, wherein the access category comprises an access category of a relatively high priority.
